(19) United States
(12) Patent Application Publication
(10) Pub. No.: US 2008/0070063 A1
(43) Pub. Date: Mar. 20, 2008

(54) Exchange coupling film and magnetic device

(75) Inventors: Takahiro Ibusuki, Kawasaki (JP); Masashige Sato, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/898,730

(22) Filed: Sep. 14, 2007

(30) Foreign Application Priority Data
Sep. 15, 2006 (JP) 2006-250737

(51) Int. Cl. G11B 5/39; G11B 5/33; G11B 5/66

(52) U.S. Cl. 428/811; 428/810; 428/828.1

(57) ABSTRACT

An exchange coupling film of the present invention has a sandwich structure with a non-magnetic layer of a Ru—Rh alloy between two ferromagnetic layers. In a case of applying the exchange coupling film of the present invention to a magnetic head (reading element), the non-magnetic layer is set to have, for example, a thickness of 0.4 nm to 0.5 nm, and a Rh content of 5 at % to 40 at %. In a case of applying the exchange coupling film of the present invention to a magnetic recording medium, the non-magnetic layer is set to have, for example, a thickness of 0.4 nm to 0.6 nm, and a Rh content of 5 at % to 70 at %. In a case of applying the exchange coupling film of the present invention to an MRAM, the non-magnetic layer is set to have, for example, a thickness of 0.3 nm to 0.7 nm, and a Rh content of 5 at % to 40 at %.

### CROSS-REFERENCE TO RELATED APPLICATIONS

This application is based on and claims priority of Japanese Patent Application No. 2006-250737 filed on Sep. 15, 2006, the entire contents of which are incorporated herein by reference.

### BACKGROUND OF THE INVENTION

1. Field of the Invention

The present invention relates to an exchange coupling film used in magnetic devices such as a reading element and a magnetic recording medium for a magnetic recording apparatus, and in a magnetic random-access memory (MRAM), and to a magnetic device including the exchange coupling film.

2. Description of the Prior Art

FIG. 1 shows a structure of an exchange coupling film 10 used in such magnetic devices as a magnetic recording medium and a reading element for a magnetic recording apparatus (hard disk drive), and a magnetic random-access memory (MRAM). The exchange coupling film 10 has a sandwich structure with a non-magnetic layer 11 between two ferromagnetic layers 12a and 12b. The ferromagnetic layers 12a and 12b are exchange coupled with their magnetization directions in the respective two ferromagnetic layers being antiparallel to each other. The magnitude of the exchange coupling strength (exchange coupling energy) depends on the thickness of the non-magnetic layer 11. This is explained in S. S. P. Parkin, Phys. Rev. Lett., 67, 3598 (1991), and in M. Saito, N. Hasegawa, K. Tanaka, Y. Ide, F. Koike, and T. Kuriyama, J. Appl. Phys., 87, 6974 (2000).

FIG. 2A is a graph illustrating the relationship between the thickness of the non-magnetic layer of ruthenium (Ru) and the saturation magnetic field Hs, and the relationship between the thickness of the non-magnetic layer of Ru and the magnetic field Hsf where the antiparallel state is collapsed. FIG. 2B is a graph illustrating the relationship between the thickness of the non-magnetic layer of chromium (Cr) and the saturation magnetic field Hs, and the relationship between the thickness of the non-magnetic layer of Cr and the magnetic field Hsf where the antiparallel state is collapsed. FIG. 2C is a graph illustrating the relationship between the thickness of the non-magnetic layer of iridium (Ir) and the saturation magnetic field Hs, and the relationship between the thickness of the non-magnetic layer of Ir and the magnetic field Hsf where the antiparallel state is collapsed. FIG. 2D is a graph illustrating the relationship between the thickness of the non-magnetic layer of rhodium (Rh) and the saturation magnetic field Hs, and the relationship between the thickness of the non-magnetic layer of Rh and the magnetic field Hsf where the antiparallel state is collapsed. These FIGS. 2A to 2D show a periodical change of the saturation field Hs in relation to the thickness of the non-magnetic layer. They also show that each of the peak intensity and the thickness of non-magnetic layer where the peak intensity is obtained are different depending on the material used in the non-magnetic layer. They also show that a thicker non-magnetic layer lowers the peak intensity.

The saturation field and the exchange coupling energy have a proportional relationship. The following equation (1) shows the relationship between saturation field Hs and exchange coupling energy J12.
J12=Hs/((1/tBS1)+(1/tBS2)). (1)

In the above equation, tBS1 is the product of the saturation magnetization and the thickness of the ferromagnetic layer 12a while tBS2 is the product of the saturation magnetization and the thickness of the ferromagnetic layer 12b.

In general, the non-magnetic layer of the exchange coupling film of a magnetic device is a Ru layer with a thickness of 0.6 nm to 0.9 nm. FIG. 2A shows a correspondence between this thickness and the second peak of the curve describing the relationship between the thickness of the non-magnetic layer and the saturation magnetic field Hs.

To investigate the stability of the device, the inventors of the present application calculated the relationship between the exchange coupling energy and the Hua of the reading element, and the relationship between the exchange coupling energy and a coercive force Hc of the recording layer of MRAM. The results are as follows. As is shown in FIG. 3, note that the Hua is the magnetic field at the time when resistance becomes ΔR/2+Rmin, by further applying magnetic fields from a high resistance state in the reading element (magneto-resistance effect element). Here, Rmin is the resistance value at the time when the reading element is in a low resistance state, and ΔR is the difference between the resistance value of the reading element in a low resistance state and the resistance value in a high resistance state. A higher Hua means a more stable magnetic field.

The Hua of the reading element was obtained by calculating the R-H (resistance-magnetic field) curve by taking the JP1P2 as a parameter, with tBsP1=3.2 nmT, and tBsP2=3.6 nmT. Here, JP1P2 is exchange coupling energy between the two ferromagnetic layers—a pinned layer and a reference layer—of the exchange coupling film—synthetic ferri pinned layer—of the reading element. The product between the film thickness of one of the ferromagnetic layers (pinned layer) and the saturation magnetization is represented by tBsP1, and the product between the film thickness of the other layer (i.e., the reference layer) and the saturation magnetization is represented by tBsP2.

FIG. 4A is a graph showing the relationship between the exchange coupling energy JP1P2 on the horizontal axis and the Hua on the vertical axis. FIG. 4A shows that a higher exchange coupling energy of the exchange coupling film forming the reading element improves the stability of the magnetic field of the reading element.

On the other hand, the coercive force of the recording layer of the MRAM is obtained by calculating the magnetizing curve by taking the JF1F2 as a parameter, with tBsF1=1.9 nmT, and tBsF2=3.6 nmT. Here, JF1F2 is exchange coupling energy between the two ferromagnetic layers of the recording layer of the MRAM. The product between the film thickness of one of the ferromagnetic layers and the saturation magnetization is represented by tBsF1, and the product between the film thickness of the other layer and the saturation magnetization is represented by tBsF2.

FIG. 4B is a graph showing the relationship between the exchange coupling energy JF1F2 on the horizontal axis and the coercive force (Hc) of the recording layer on the vertical axis. FIG. 4B shows that a higher exchange coupling energy of the exchange coupling film increases the coercive force of the recording layer of the MRAM, and that the higher exchange coupling energy improves the stability against the magnetic field and the thermal stability of the recording layer of the MRAM.

In addition, it is a well-known fact that, in a magnetic recording medium (magnetic disc), a larger exchange coupling energy of the underlayer (Antiparallel coupled SUL: APS) suppresses a side erasure and a spike noise, and that the higher exchange coupling energy prevents the recording area from spreading.

FIG. 5 shows the relationship between the magnetic permeability (μ 90%) on the horizontal axis and the signal attenuation due to the side erasure (i.e., Adjacent Track Erasure: ATE) on the vertical axis (see J. Zhou, B. R. Acharya, P. Gill, and E. N. Abarra, IEEE Trans. on Magn., 40, 3160 (2005).). FIG. 5 shows that a lower magnetic permeability (μ 90%) reduces the signal attenuation due to the side erasure. The higher the exchange coupling energy of the exchange coupling film (underlayer) is, the lower the magnetic permeability (μ 90%) is. It can be said, therefore, that a higher exchange coupling energy of the exchange coupling film reduces the side erasure.

Beside those described above, Japanese Patent Application No. 2006-31932, Japanese Patent Application No. 2001-143223, Japanese Patent Application No. 2004-103125 disclose some conventional technologies related to the present invention. Japanese Patent Application No. 2006-31932 describes a perpendicular magnetic recording medium with a non-magnetic layer containing ruthenium arranged between a hard magnetic layer and a soft magnetic layer. It also describes a perpendicular magnetic recording medium with a non-magnetic layer containing at least one of vanadium, chromium, copper, molybdenum and rhodium arranged between a hard magnetic layer and a soft magnetic layer. Japanese Patent Application No. 2001-143223 describes a spin-valve type thin film magnetic element (magnetic head) which has a structure in which a fixed magnetic layer or a free magnetic layer is separated into a first magnetic layer and a second magnetic layer by a non-magnetic intermediate layer. Japanese Patent Application No. 2004-103125 describes a structure and an operation of an MRAM.

In general, as described above, the conventional non-magnetic layer of an exchange coupling film is a Ru layer with a thickness of 0.6 nm to 0.9 nm. In a case where a Ru layer is used for the non-magnetic layer of an exchange coupling film, however, it is obvious from the viewpoint of the stability of the magnetic device that the thickness of the Ru layer is preferably 0.3 nm to 0.4 nm. In other words, the Ru layer preferably has a thickness corresponding to the first peak of the curve of FIG. 2A showing the relationship between the thickness of the non-magnetic layer and the saturation magnetic field Hs. Furthermore, it is obvious from FIGS. 2A to 2D that use of an Ir or Rh layer as the non-magnetic layer of the exchange coupling film increases the exchange coupling strength, as compared to a case where a Ru layer is used. The following are some reasons for the conventional use of the Ru layer with a thickness of 0.6 nm to 0.9 nm over other kinds of layer mentioned above.

The use of a Ru layer with a thickness of 0.3 nm to 0.4 nm as the non-magnetic layer of the exchange coupling film requires a formation of the film which has a thickness equivalent to a couple of Ru atoms, and which is formed evenly. Given today's state of art, however, it is difficult to form the Ru film with an even thickness equivalent of a couple of atoms. If it is tried, the manufacturing costs will be skyrocketed. In addition, the narrow peak width of the first Ru peak brings about another problem—a slight change in film thickness may cause a big change in the exchange coupling strength.

As is described in S. S. P. Parkin, Phys. Rev. Lett., 67, 3598 (1991) and in M. Saito, N. Hasegawa, K. Tanaka, Y. Ide, F. Koike, and T. Kuriyama, J. Appl. Phys., 87, 6974 (2000), both of which are mentioned above, the use of a Rh or Ir layer as the non-magnetic layer causes an exchange coupling strength to be higher than the exchange coupling energy caused by the use of Ru layer. In addition, use of a Rh or Ir layer as the non-magnetic layer tolerates a comparatively thicker non-magnetic layer with a thickness of 0.5 nm to 0.7 nm to obtain a high exchange coupling strength. These advantages lead to the idea of using a Rh or an Ir layer as the non-magnetic layer of the exchange coupling film.

The exchange coupling film with a Rh or Ir non-magnetic layer, however, has a problem of losing its exchange coupling strength after a heat treatment. This heat treatment is necessity to induce uni-direction anisotropy at the interface of antiferromagnetic layer and pinned layer.

FIG. 6 shows the exchange coupling energies of the exchange coupling film preceding and following a heat treatment, with the thickness of the non-magnetic layer on the horizontal axis and the exchange coupling energy on the vertical axis, while a Ru layer, a Rh layer or an Ir layer is used as the non-magnetic layer. The exchange coupling energy before and after the heat treatment are shown for each of the layers. Note that, as shown in FIG. 7, test samples used in this experiment has the following configurations. In each of the test samples, a Ru layer 22 with a thickness of 3 nm is formed on a base plate 21. An exchange coupling film 23 is formed on the Ru layer 22, and another Ru layer 26, which has a thickness of 5 nm, is formed on the exchange coupling film 23. The exchange coupling film 23 includes a CoFe layer (lower ferromagnetic layer) 24a, which has a thickness of 3 nm, and another CoFe layer (upper ferromagnetic layer) 24b, which has a thickness of 4 nm. In addition, the exchange coupling film 23 of each test sample has a non-magnetic layer 25 of Ir, Rh or Ru.

FIG. 6 shows that the exchange coupling film with a Rh or an Ir non-magnetic film loses its exchange coupling energy after the heat treatment, though it has had a high exchange coupling energy before the heat treatment. In contrast, the heat treatment does not affect the level of exchange coupling energy of the exchange coupling film with a Ru non-magnetic layer. Accordingly, Rh or Ir layer cannot be used as the non-magnetic layer in a case where the exchange coupling film is subjected to a heat treatment after it is formed.

Studies of the inventors of the present application has revealed that, in a case where the ferromagnetic layer of the exchange coupling film is made of, for example, a CoFeB layer, use of a Rh non-magnetic layer makes the exchange coupling unobtainable. This means that Rh layer cannot be used as the non-magnetic layer even in a case where no heat treatment is needed.

### SUMMARY OF THE INVENTION

Another object of the present invention is to provide an exchange coupling film which has a exchange coupling strength higher than that of a conventional one, which can be manufactured with ease, and which does not lose its exchange coupling strength even with a heat treatment. Providing a magnetic device with such an exchange coupling film is also pursued by the present invention.

According to an aspect of the present invention, an exchange coupling film with the following characteristics is provided. The exchange coupling film has a first and a second ferromagnetic layers, which are arranged with a non-magnetic layer in between, and which are exchange coupled with the magnetization directions in the two layers being antiparallel. In addition, the non-magnetic layer is made of a Ru—Rh alloy.

Application of the exchange coupling film of the invention of the present application to a reading element of a magnetic head improves the stability of the magnetic field and heat resistance of the magnetic head. Additionally, application of the exchange coupling film of the present invention to a magnetic reading medium suppresses the side erasure and the spike noise, and prevents the recording area from spreading. Furthermore, application of the exchange coupling film of the present invention to an MRAM increases the coercive force of the recording layer of the MRAM, and improves the stability of the magnetic field and the heat resistance of the recording layer of the MRAM.

### BRIEF DESCRIPTION OF THE DRAWINGS

FIG. 1 is a perspective view showing a conventional exchange coupling film.

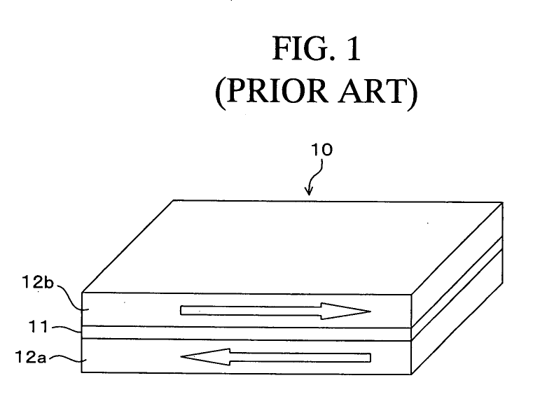

FIGS. 2A to 2D are graphs showing, respectively, relationships between the thickness of each of the non-magnetic layers respectively of Ru, Cr, Ir and Rh, and the saturation magnetic field Hs and the magnetic field Hsf where the antiparallel state is collapsed.

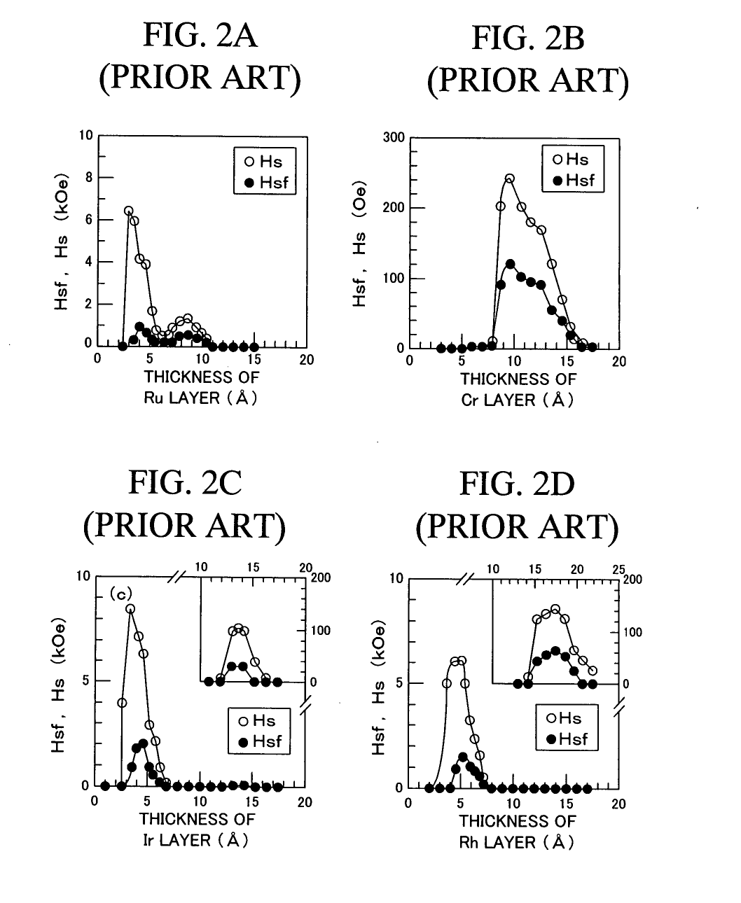

FIG. 3 is a chart showing the definition of the Hua.

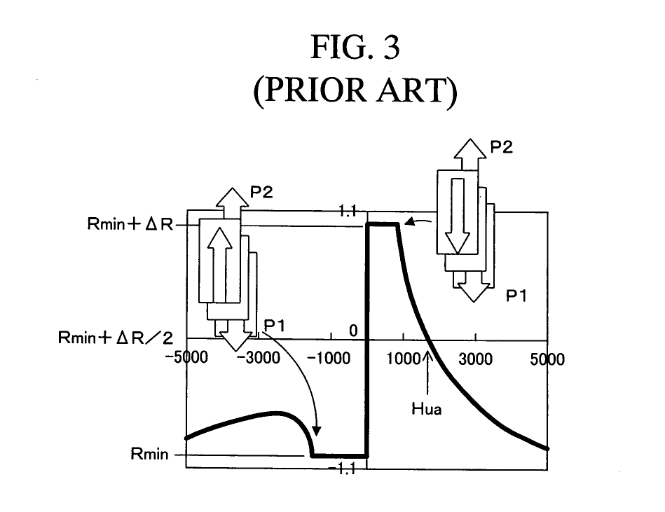

FIG. 4A is a graph showing a relationship between the exchange coupling energy JP1P2 and the Hua, and FIG. 4B is a graph showing the relationship between the exchange coupling energy JF1F2 and the Hc (coercive force).

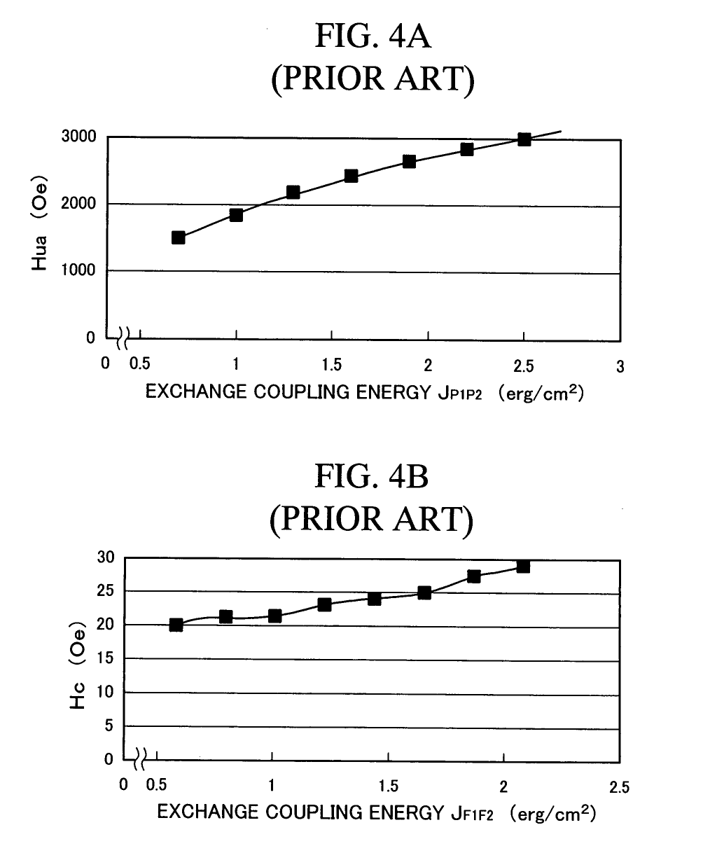

FIG. 5 is a graph showing a relationship between the magnetic permeability (μ 90%) and the signal attenuation due to the side erasure (ATE).

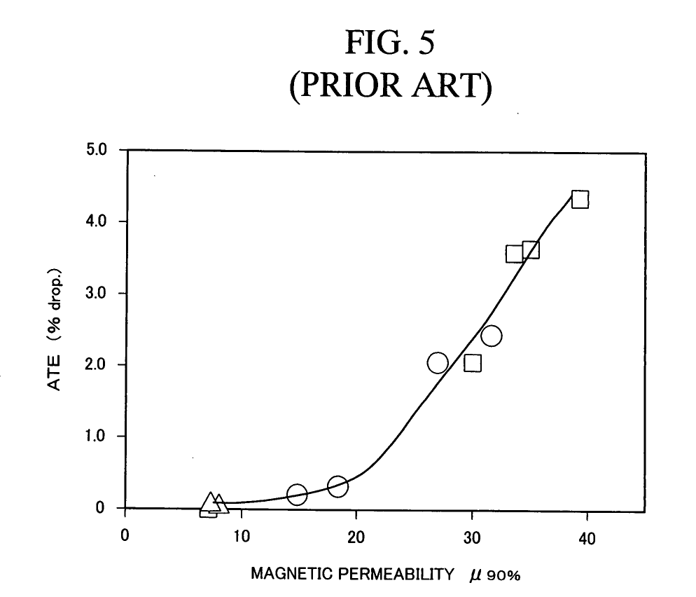

FIG. 6 is a graph showing the exchange coupling energies of the exchange coupling films respectively with a non-magnetic layer of Ru, Rh or Ir preceding the heat treatment, and those following the heat treatment.

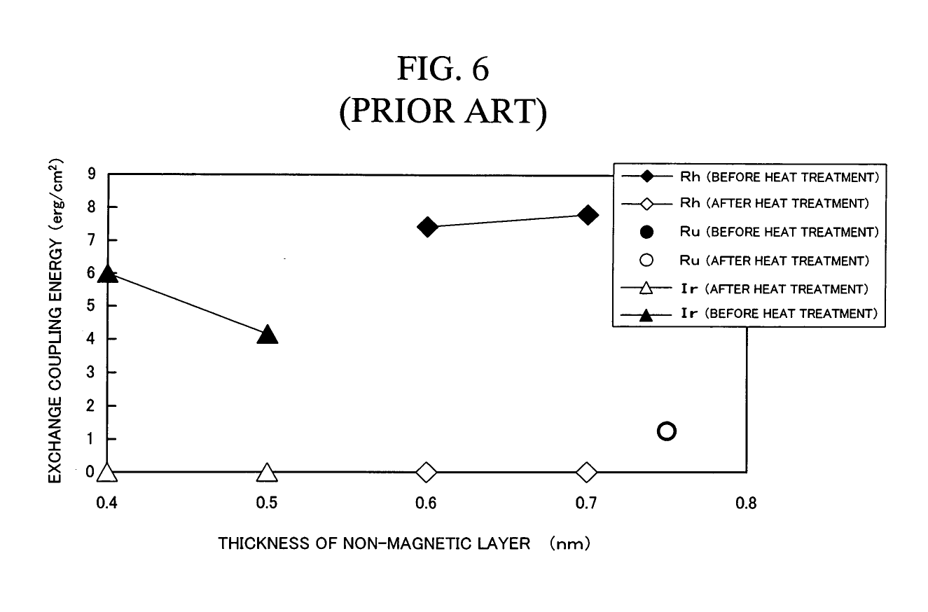

FIG. 7 is a sectional view showing the structure of a test sample used when the exchange coupling energies preceding and following the heat treatment are measured.

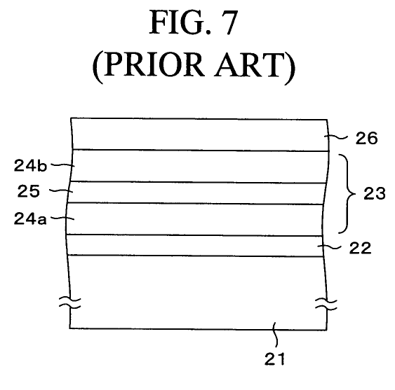

FIG. 8 is a perspective view showing an exchanging coupling film of an embodiment of the present invention.

FIG. 9A is a graph showing a relationship between the thickness of each of the non-magnetic layers, respectively made of Ru, Rh and Ru—Rh alloys, included in the respective exchange coupling films and the exchange coupling energy preceding a heat treatment. FIG. 9B is a graph showing the relationship between the thickness of each of the same non-magnetic films and the exchange coupling energy following the heat treatment.

FIG. 10 is a sectional view showing the structure of a test sample used to investigate the exchange coupling energies preceding and following the heat treatment.

FIG. 11 is a sectional view showing the configuration of a magnetic head of the present invention.

FIGS. 12A to 12C are sectional views explaining a method of manufacturing the TMR element constituting a magnetic head, shown in the order of manufacturing steps.

FIG. 13 is a table showing the configurations of the respective magnetic heads of the experimental examples 1 to 4.

FIG. 14 shows the measurement results of thermal resistance of magnetic heads respectively of experimental examples 1 to 4.

FIG. 15 shows R—H curves of the magnetic head of the experimental example 1 (Comparative Example) at 30° C., 100° C., 150° C. and 200° C.

FIG. 16 shows the measurement results of the pin reversal probability of the magnetic heads respectively of experimental examples 1 to 4 at each measurement temperature.

FIG. 17A to 17C are sectional views describing the method of manufacturing a perpendicular magnetic recording medium.

FIG. 18 is a plan view showing a magnetic recording apparatus.

FIG. 19 is a sectional view showing a TMR element constituting an MRAM.

### DESCRIPTION OF THE PREFERRED EMBODIMENT

Explanations will be given below of an embodiment of the present invention by referring to the accompanying drawings.

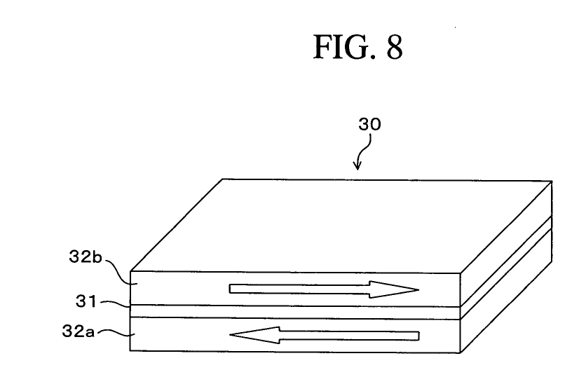

FIG. 8 is a perspective view showing an exchanging coupling film of an embodiment of the present invention. As is shown in this FIG. 8, the exchange coupling film 30 of the present embodiment has a sandwich structure which includes two ferromagnetic layers 32a and 32b with a non-magnetic layer 31, which is made of an Ru—Rh alloy, in between. The ferromagnetic layers 32a and 32b are made of a ferromagnetic material containing at least one of Co, Ni and Fe. The two layers 32a and 32b are magnetically coupled with the magnetization directions of the two layers being arranged antiparallel to each other.

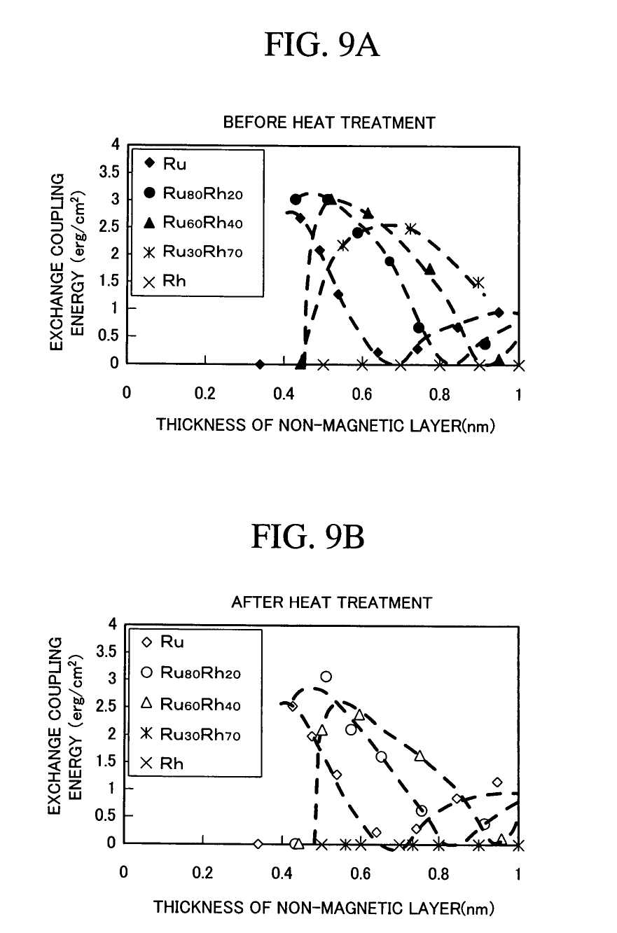

FIG. 9A is a graph showing a relationship between the thickness of each of non-magnetic layers on the horizontal axis and the exchange coupling energy on the vertical axis. Here, the non-magnetic layers include a Ru layer, a Rh layer and a Ru—Rh alloy layer, and the exchange coupling energies are measured before the exchange coupling film with each kind of layer is subjected to a heat treatment. FIG. 9B is a graph showing a relationship between the thickness of each of non-magnetic layers on the horizontal axis and the exchange coupling energy on the vertical axis. Here, the non-magnetic layers include a Ru layer, a Rh layer and Ru—Rh alloy layers, and the exchange coupling energies are measured after the exchange coupling film with each kind of layer is subjected to a heat treatment at 300° C. Note that, in FIGS. 9A and 9B, Ru30Rh70 is a Ru—Rh alloy with a Ru content of 30 at % and a Rh content of 70 at %. Ru60Rh40 is a Ru—Rh alloy with a Ru content of 60 at % and a Rh content of 40 at %. Ru80Rh20 is a Ru—Rh alloy with a Ru content of 80 at % and a Rh content of 20 at %.

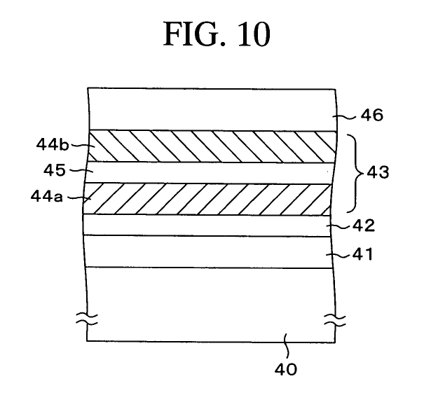

Here, the test sample has such a structure as is shown in FIG. 10. On a base plate 40, a Ta layer 41 with a thickness of 3 nm and a Ru layer 42 with a thickness of 2 nm are formed. Then, on the Ru layer 42, an exchange coupling film 43 is formed, and on the exchange coupling film 43, a Ru layer 46 with a thickness of 3 nm is formed. The exchange coupling film 43 is made up of a CoFeB layer (lower ferromagnetic layer) 44a with a thickness of 3 nm, a non-magnetic layer 45 made of Ru, Rh or a Ru—Rh alloy, and a CoFe layer (upper ferromagnetic layer) 44b with a thickness of 5 nm.

FIGS. 9A and 9B show the following facts. Use of a Ru—Rh alloy as a non-magnetic layer shifts the first peak to the right (to a position where the layer is thicker), and renders the peak width wide. With a larger Rh content, the peak is shifted further to the right, and the width thereof is wider. Additionally, what is observed in the exchange coupling film with a non-magnetic layer of the Ru—Rh alloy with a Rh content of 70 at % (Ru30Rh70 alloy) is an exchange coupling preceding a heat treatment, but the loss of it following the heat treatment. The experiment of the inventors of the present application revealed that a 5 at % or higher Rh content was necessary for the peak position to shift sufficiently to the side where the layer is thicker. It also revealed that a 40 at % or lower Rh content was necessary for the exchange coupling to be maintained after the heat treatment. In this case, the thickness of the non-magnetic layer, which corresponded to the first peak, was 0.3 nm to 0.7 nm.

In other words, use of a Ru—Rh alloy with a Rh content of 5 at % to 40 at % as the non-magnetic layer of the exchange coupling film renders the non-magnetic layer thicker when the first peak appears, in comparison to the case of using Ru for the non-magnetic layer. In addition, the use of such a Ru— Rh alloy causes the exchange coupling strength to be maintained even after the exchange coupling film is subjected to a heat treatment, for example, at 200° C. or higher. Especially, in a case of a Rh content of 20 at % to 30 at %, the exchange coupling strength is approximately 10% larger than that in the case of using the Ru non-magnetic layer. With this larger exchange coupling strength, the magnetic device with such a Ru—Rh alloy is more stable. Additionally, in this case, the non-magnetic layer can be made to be a relatively thick layer with a thickness of 0.4 nm to 0.7 nm. This results in an easy formation of a non-magnetic layer with an even thickness.

Furthermore, as is shown in FIG. 9A, use of the Rh layer as the non-magnetic layer together with a CoFeB upper ferromagnetic layer renders no exchange coupling strength. For this reason, use of a CoFeB ferromagnetic layer of the exchange coupling film is conventionally accompanied by use of a Ru non-magnetic layer. The use of Ru non-magnetic layer, however, did not produce a large exchange coupling strength. This is because the Ru layer needs to be formed to have a thickness of 0.6 nm to 0.9 nm for the reasons explained above. Even in such a case, that is, in a case of using a CoFeB upper ferromagnetic layer, use of a Ru—Rh alloy non-magnetic layer of a thickness of 0.3 nm to 0.7 nm can produce a large exchange coupling strength. In other words, according to the present invention, in a case where no heat treatment at a high temperature is needed after the formation of the exchange coupling film, the use of a Ru—Rh alloy non-magnetic layer can produce a exchange coupling strength larger than that in a case of a conventional exchange coupling film. In such a case of using a Ru—Rh alloy non-magnetic layer, the layer preferably has a Rh content of 70 at % or lower.

(Magnetic Head)

Explanations will be given below of an example of the present invention applied to a ferri pinned layer of the reading element of a magnetic head (magnetoresistance effect element).

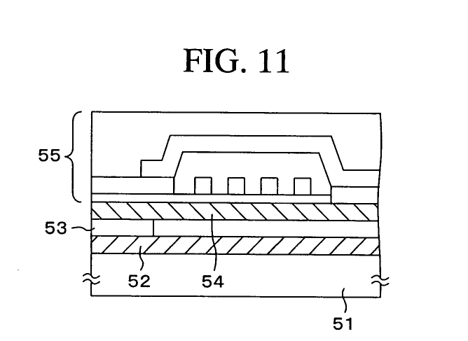

FIG. 11 is a sectional view showing the configuration of a magnetic head. As is shown in this FIG. 11, the magnetic head of a magnetic recording apparatus has the following configuration. On a base plate 51 to be a slider, a lower magnetic shield layer 52 is formed. On the lower magnetic shield layer 52, a reading element (magnetoresistance effect element) 53 is formed, and the reading element 53 reads out information from a magnetic recording medium (magnetic disc). Over the reading element 53, an upper magnetic shield layer 54 is formed and on the upper magnetic shield layer 54, a writing element (inductive head) 55 for writing information in the magnetic recording medium. The reading element 53 is formed of a tunnel magnetoresistance effect film, and a CIP spin valve film or a CPP spin valve film. Here, the reading element 53 is made of a TMR element with a tunnel magnetoresistance effect film.

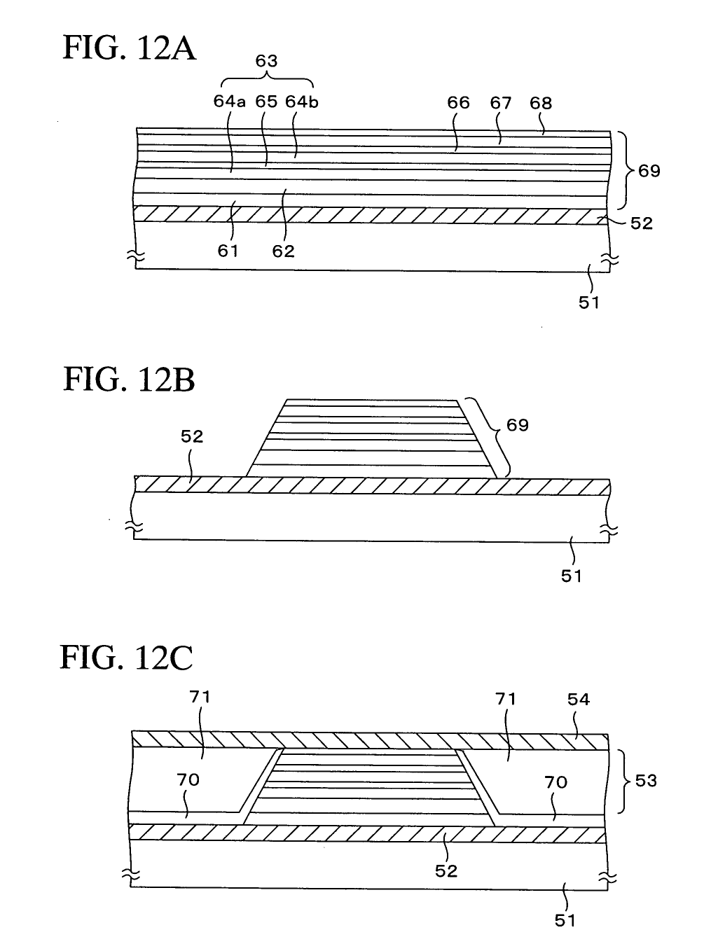

FIGS. 12A to 12C are sectional views explaining a method of manufacturing the TMR element, shown in the order of manufacturing steps. By referring to these FIGS. 12A to 12C, the method of manufacturing the TMR element will be explained. Note that, here, each of the layers forming the TMR element is formed by a sputtering method, and that the illustrations in FIGS. 12A to 12C are respectively views of the structures seen from the side of the magnetic recording medium (i.e., from the left in FIG. 10).

Now, steps up to a point where the structure shown in FIG. 12A is formed will be explained. Firstly, an Al₂O₃ film (not illustrated) is formed on a base plate 51 of a non-magnetic material such as Al—TiC. On the Al₂O₃ film, a lower magnetic shield layer 52 made of, for example, NiFe, is formed in a thickness of 2 μm to 3 μm. Then, on the lower magnetic shield layer 52, an underlayer 61 is formed in a thickness of 5 nm or thicker. This underlayer 61 is formed of, for example, a Ta/Ru laminate film, a Ta/NiFe laminate film, a NiCr film or a NiFeCr film.

Secondly, on the underlayer 61, an antiferromagnetic layer 62 is formed in, for example, a thickness of 5 nm. The antiferromagnetic layer 62 is formed of, for example, an IrMn film, a PtMn film or a PdPtMn film.

Thirdly, on the antiferromagnetic layer 62, a CoFe layer with a thickness of 1.5 nm is formed as a lower ferromagnetic layer (pinned layer) 64a. Then, on the lower ferromagnetic layer 64a, a Ru80Rh20 alloy layer with a thickness 0.5 nm is formed as a non-magnetic layer 65. Furthermore, on the non-magnetic layer 65, a CoFeB layer with a thickness of 2.5 nm is formed as an upper ferromagnetic layer (reference layer) 64b. With these layers, that is, the lower ferromagnetic layer 64a, the non-magnetic layer 65 and the upper ferromagnetic layer 64b, an exchange coupling film (synthetic ferri pinned layer) 63 of the embodiment of the present invention is formed.

Note that the non-magnetic layer 65 is preferably made of a Ru—Rh alloy with a Rh content of 5 at % to 40 at %. Use of a Ru—Rh alloy with a Rh content of 20 at % to 30 at % is more preferable. In addition, the non-magnetic layer 65, preferably, is 0.3 nm to 0.7 nm thick, and more preferably is 0.4 nm to 0.7 nm.

Fourthly, on the exchange coupling film 63, a MgO layer with a thickness of 1.0 nm is formed as a tunnel barrier layer 66. Then, on the tunnel barrier layer 66, a CoFeB layer with a thickness of 3.0 nm is formed as a free layer 67. After that, on the free layer 67, a Ta layer, a Ru layer or a Ta/Ru laminate layer with a thickness of 3 nm or thicker is formed as a cap layer 68. In this way, a magnetoresistance effect film 69 is formed of the underlayer 61, the antiferromagnetic layer 62, the exchange coupling film (synthetic ferri pinned layer) 63, the tunnel barrier layer 66, the free layer 67 and the cap layer 68. After these deposition, heat treatment at 300° C. for 3 hours take place for inducing uni-direction anisotropy at the interface of antiferromagnetic layer 63 and pinned layer 64a.

Fifthly, a resist pattern with a predetermined shape (not illustrated) is formed on the magnetoresistance effect film 69 by a photoresist method. Using this resist pattern as a mask, the magnetoresistance effect film 69 is processed into a predetermined shape as is shown in FIG. 12B by Ion milling carried out until the lower magnetic shield layer 51 is exposed.

Next, steps up to a point where the structure shown in FIG. 12C is formed will be explained. Firstly, after the magnetoresistance effect film 69 is processed, as is described above, into the specific predetermined shape, an insulating film 70 is formed in a thickness of 3 nm to 10 nm on the entire upper side of the base plate 50. When the insulating film 70 is formed, a sputtering method is carried out with the resist pattern being left as it is. Then, another sputtering is carried out to deposit Cr/CoCrPt on the insulating film 70 so that magnetic domain control layers 71 are formed on both sides of the magnetoresistance effect film 69. After that, the resist pattern is removed.

Secondly, after surfaces of the respective magnetic domain control layers 71 are made flat, an upper magnetic shield layer 54 is formed in a thickness of 2 μm to 3 μm on the magnetoresistance effect film 69 and on the magnetic domain control layers 71. The upper magnetic shield layer 54 is made, for example, of NiFe. In this way, the formation of a reading element (TMR element) 53 arranged between the lower magnetic shield layer 52 and the upper magnetic shield layer 54 is completed.

Thirdly, the writing element 55, which includes a main magnetic pole, a coil and an auxiliary magnetic pole, is formed on the upper magnetic shield layer 54 by a known method (see FIG. 11). In this way, the manufacturing of the magnetic head of this embodiment is completed.

In the magnetic head formed in such a way as is described in FIGS. 12A to 12C, the magnetization direction of the free layer 67 changes in response to the magnetic field based on the information recorded in the magnetic recording medium. This results in a change in the resistance of the reading element 53. By electrically detecting this change in the resistance, the information recorded in the magnetic recording medium is read out.

Explanations will be given below of the results of investigation on properties of the magnetic head (recording element) formed in the way described above.

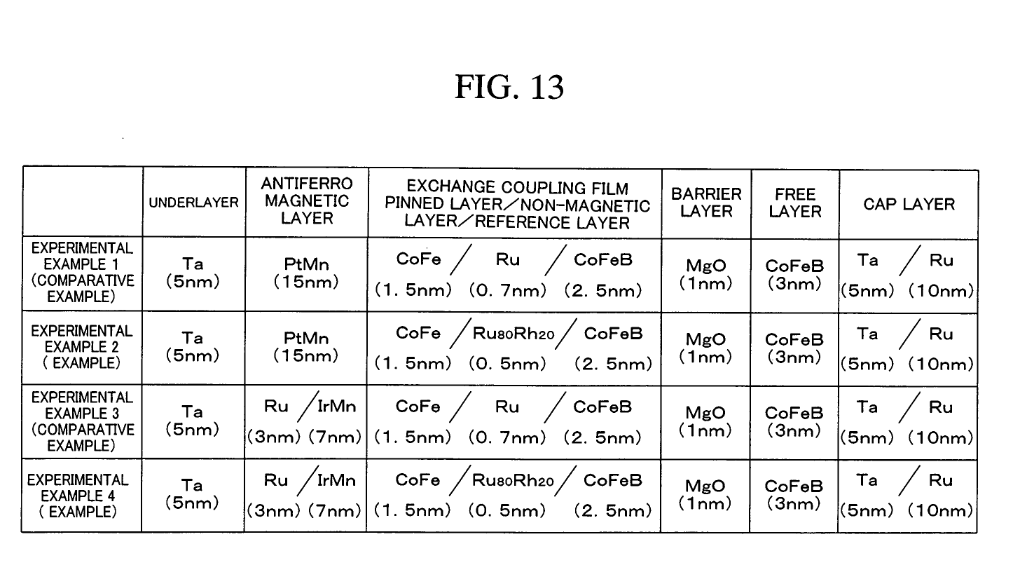

Magnetic heads respectively of experimental examples 1 to 4 are manufactured in the way described above. The Configurations respectively of these magnetic heads are shown together in FIG. 13. Note that the magnetic heads of the respective experimental examples 2 and 4 are the magnetic heads of Examples of the present invention, while magnetic heads of the respective experimental examples 1 and 3 correspond to comparative examples.

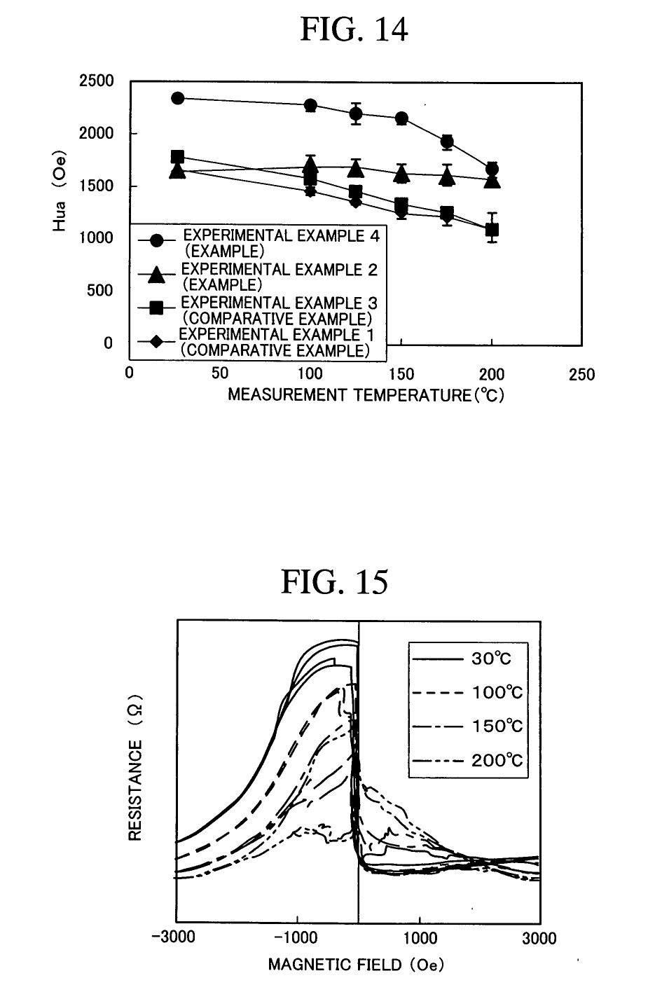

FIG. 14 is a graph showing the measurement results of thermal resistance on magnetic heads respectively of experimental examples 1 to 4 with the measurement temperature on the horizontal axis and the Hua on the vertical axis. FIG. 14 shows that, at a lower measurement temperature, the magnetic heads of the respective experimental examples 3 and 4 each with an IrMn antiferromagnetic layer have a Hua higher than the magnetic heads of experimental examples 1 and 2 each with a PtMn antiferromagnetic layer. At a higher measurement temperature, however, the magnetic heads of the respective experimental examples 1 and 3 (Comparative Examples) each with a Ru non-magnetic layer have a Hua smaller than the magnetic heads of the respective experimental examples 2 and 4 (Examples) each with a Ru80Rh20 non-magnetic layer.

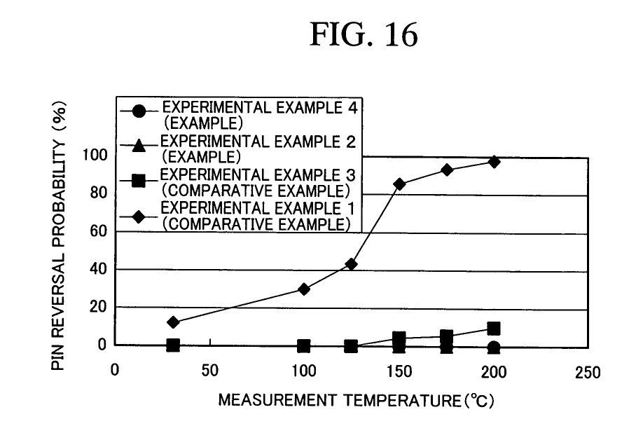

FIG. 15 shows R—H curves of the magnetic head of the experimental example 1 (Comparative Example) respectively at 30° C., 100° C., 150° C. and 200° C. FIG. 15 shows that turbulence occurs in each of the R—H curves at 150° C. or higher in the magnetic head of experiment example 1, and that the difference in resistance between a case of applying a plus magnetic field and a case of applying a minus magnetic field is small. This indicates a pin reversal occurring in the ferri pinned layer of the magnetic head.

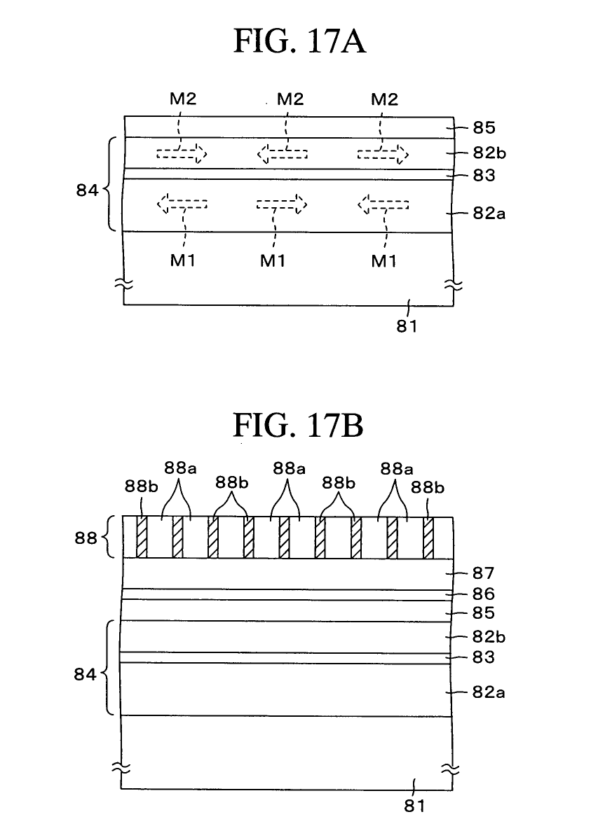

FIG. 16 is a graph showing the measurement results of the pin reversal probability of the magnetic heads respectively of experimental examples 1 to 4 at each measurement temperature with the measurement temperature on the horizontal axis and the pin reversal probability on the vertical axis. Note that, in this case, each pin reversal probability is obtained from 50 samples for each of experimental examples 1 to 4.

FIG. 16 shows that a pin reversal occurs at a temperature of 30° C. or higher in experimental example 1 (Comparative Example), and at a temperature of 125° C. or higher in experimental example 3 (Comparative Example). In contrast, no pin reversal occurs even at a temperature of 200° C. in experimental examples 2 and 4 (both of which are Examples). This indicates that the magnetic head (reading element) with the exchange coupling film of the present invention has a higher stability of magnetic field and a higher heat resistance than those of the magnetic head with a Ru non-magnetic layer has.

In this embodiment, the use of a Ru80Rh20 non-magnetic layer with a thickness of 0.4 nm to 0.5 nm produces an exchange coupling strength three times as large as the use of a Ru non-magnetic layer with a thickness of 0.8 nm does, and approximately 1.1 times as large as the use of a Ru non-magnetic layer with a thickness of 0.4 nm does.

(Magnetic Recording Medium)

Explanations will be given below of an example of the present invention applied to an underlayer of a perpendicular magnetic recording medium.

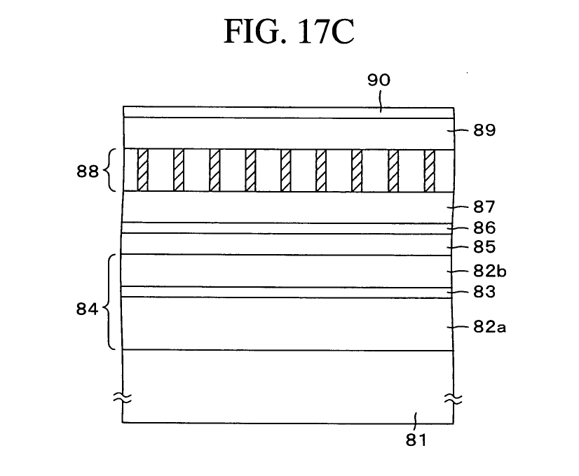

FIGS. 17A to 17C are sectional views describing the method of manufacturing a perpendicular magnetic recording medium in the order of manufacturing steps.

Now, steps up to a point where the structure shown in FIG. 17A is formed will be explained. Firstly, a base plate 81 is prepared, for example, in a shape of a disc with a diameter of 2.5 inches, and then the surface of the base plate 81 is plated, for example, with NiP. The base plate 81 has to be non-magnetic, to have a flat surface, and to be mechanically strong. The base plate 81 can be an aluminum alloy plate, a crystallized glass plate, a glass plate with its surface being chemically strengthened, a silicon base plate with a thermally oxidized film formed on its surface, a plastic plate, or the like.

Secondly, a first soft magnetic layer (lower ferromagnetic layer) 82a with an amorphous structure is formed on the base plate 81. The soft magnetic layer 82a is formed by depositing CoNbZr in, for example, a thickness of 25 nm, by a direct current (DC) sputtering method with an input electric power of 1 kW in an argon (Ar) atmosphere under a pressure of 0.5 Pa.

The first soft magnetic layer 82a, however, is not limited to a CoNbZr layer. The first soft magnetic layer 82a can be a layer made of an alloy with an amorphous or microcrystal structure containing at least one element chosen from cobalt (Co), iron (Fe), and nickel (Ni), and at least one element chosen from zirconium (Zr), tantalum (Ta), carbon (C), niobium (Nb), silicon (Si) and boron (B). Examples of such materials are CoNbTa, FeCoB, NiFeSiB, FeAlSi, FeTaC and FeHfC. In consideration of suitability to mass-production, the saturation magnetization of the first soft magnetic layer 82a is preferably at approximately 1 T (tesla).

Incidentally, the first soft magnetic layer 82a is formed by a DC sputtering method in this embodiment. Other methods such as a radio frequency (RF) sputtering method, a pulse DC sputtering method, and a chemical vapor deposition (CVD) method can replace the DC sputtering method. This also applies to any process described later with a DC sputtering method.

Thirdly, a non-magnetic layer 83 is formed on the first soft magnetic layer 82a.

For example, a Ru—Rh alloy layer with a thickness of 0.5 nm is formed as the non-magnetic layer 83, by a DC sputtering method with an input electric power of 150 W in an Ar atmosphere under a pressure of 0.5 Pa.

Fourthly, a second soft magnetic layer (upper ferromagnetic layer) 82b is formed on the non-magnetic layer 83. The second soft magnetic layer 82b is formed by depositing CoNbZr in, for example, a thickness of 5 nm, by a DC sputtering method with an input electric power of 1 kW in an Ar atmosphere under a pressure of 0.5 Pa. The material of the second soft magnetic layer 82b is not limited to CoNbZr. As in the case of the first soft magnetic layer 82a, the second soft magnetic layer 82b can be a layer made of an alloy with an amorphous or microcrystal structure containing at least one element chosen from Co, Fe, and Ni, and at least one element chosen from Zr, Ta, C, Nb, Si and B. In this way, an underlayer (exchange coupling film) 84 is formed, as being made up of the soft magnetic layers (ferromagnetic layers) 82a and 82b, and the non-magnetic layer 83.

The underlayer 84 has a laminate structure with the two soft magnetic layers (the first soft magnetic layer 82a and the second soft magnetic layer 82b) sandwiching the non-magnetic layer 83. In the underlayer 84, as is shown in FIG. 17A, the first and the second soft magnetic layers 82a and 82b are stabilized in a state in which the two soft magnetic layers are antiferromagnetically coupled. Specifically, the saturation magnetizations Ms1 and Ms2 of the first and the second soft magnetic layers 82a and 82b, respectively, which are adjacent to each other, through the non-magnetic layer 83 being interposed in between, have directions opposite each other, that is, the two directions are antiparallel. Such an antiferromagnetic coupling state appears periodically by increasing the thickness of the non-magnetic layer 83. The non-magnetic layer 83 is preferably made to have a thickness equivalent to the thickness corresponding to that at which this state first appears. A non-magnetic layer 83 made of Ru80Rh20 should be formed in a thickness of, for example, 0.4 nm to 0.6 nm.

As is described above, the saturation magnetization Ms1 of the first soft magnetic layer 82a and the saturation magnetization Ms2 of the second soft magnetic layer 82b have directions opposite to each other (antiparallel). As a result, magnetic fluxes due to respective magnetizations balance each other out, and the underlayer 84 as a whole has substantially a zero magnetic moment when there is no external magnetic field. This, in turn, results in a reduction of leakage magnetic flux which leaks out of the underlayer 84, and the spike noise generated by the leakage magnetic flux at the time of reading data out is also decreased.

The non-magnetic layer 83 is preferably formed of a Ru—Rh alloy with a Rh content of 5 at % to 70 at %. In addition, the thickness of the non-magnetic layer 83 is preferably 0.3 nm to 0.7 nm, and more preferably, 0.4 nm to 0.7 nm.

For an easy recording and reproducing with the magnetic head, the underlayer 84, with a saturation magnetic flux density Bs being 1 T or higher, is preferably made to have a film thickness of 10 nm or thicker, and more preferably, 30 nm or thicker. An excessively thick film for the underlayer 84, however, leads to an increase in manufacturing costs. For this reason, the film thickness of the underlayer 84 is preferably 100 nm or thinner, and more preferably, 60 nm or thinner.

Fifthly, a FeCoB layer with a thickness of approximately 10.5 nm is formed on the second soft magnetic layer 82b by a magnetron sputtering method in an Ar atmosphere under a pressure of 0.67 Pa. This FeCoB layer is made to be a seed layer 85.

For an improvement in magnetic properties of the FeCoB seed layer 85, the seed layer 85 needs to be made in a thickness of 3 nm or thicker. In consideration of easiness in controlling the film thickness at the time of mass-production and the electromagnetic conversion characteristic, the seed layer 85 is preferably made in a thickness of 5 nm or thicker.

Next, steps up to a point where the structure shown in FIG. 17B is formed will be explained. Firstly, after the formation of the underlayer 84 and the FeCoB seed layer 85 in the above described way, a crystalline orientation control layer 86 is formed on the FeCoB seed layer 85. The crystalline orientation control layer 86, which has face-centered cubic (fcc) structure, is formed by depositing non-magnetic NiFeCr by a sputtering method in an Ar atmosphere under a pressure of 0.67 Pa. The FeCoB seed layer 85 is formed under this crystalline orientation control layer 86, so that the crystalline orientation control layer 86 has a favorable fcc structure irrespective of the surface state of the second soft magnetic layer 82b. The crystalline orientation control layer 86 is preferably made in a thickness of 3 nm or thicker for a better controlling of crystalline orientations of a foundation layer 87, and recording layers 88 and 89, all of which are formed on the crystalline orientation control layer 86.

Note that the crystalline orientation control layer 86 can be made either of a non-magnetic material or of a magnetic material. In a case where the crystalline orientation control layer 86 is made of a non-magnetic material, an excessive thickness thereof expands the distance between the magnetic head and the underlayer 84. This makes an improvement in recording density difficult. For this reason, the crystalline orientation control layer 86 of a non-magnetic material is made to have a thickness of 20 nm or thinner, or more preferably to have a thickness of 10 nm or thinner. On the other hand, in a case where the crystalline orientation control layer 86 is made of a magnetic material, an excessive film thickness thereof brings about an increase in noise from the crystalline orientation control layer 86, which results in a deterioration of the S/N ratio. For this reason, the crystalline orientation control layer 86 of a magnetic material is made preferably to have a thickness of 10 nm or thinner.

Secondly, a Ru layer with a thickness of approximately 20 nm is formed on the crystalline orientation control layer 86 by a DC sputtering method with an input electric power of 250 W in an Ar atmosphere under the pressure of 8 Pa. The Ru layer thus formed is made to be the non-magnetic foundation layer 87. The film of the Ru layer constituting this non-magnetic foundation layer 87 is formed on the crystalline orientation control layer 86 with an fcc structure, so that the Ru layer has a hexagonal close-packed (hcp) crystal structure with a favorable crystallinity.

Incidentally, as the non-magnetic foundation layer 87, a layer made of an alloy containing Ru and any one element of Co, Cr, tungsten (W) and rhenium (Re) may replace the Ru layer. In addition, the non-magnetic foundation layer 87 is not limited to a layer with a single-layer structure. The non-magnetic foundation layer 87 may be formed to include two or more layers for the purpose of, for example, improving the electromagnetic conversion characteristic.

Thirdly, the first recording layer 88 is formed on the non-magnetic foundation layer 87 by a DC sputtering method using a target of CoCrPt and SiO₂. The sputtering at this time is carried out under the conditions of, for example, an Ar atmosphere and a 350 W input electric power. In this way, the first recording layer 88 is formed to have a granular structure in which magnetic particles 88b of CoCrPt are dispersed in a non-magnetic material (SiO₂) 88a. Though there is no particular limitation on the thickness of the first recording layer 88, the first recording layer, here, is made to have a thickness of 11 nm.

The non-magnetic foundation layer 87 made of Ru, which is just below the first recording layer 88, has an hcp crystal structure, and functions as to align the orientations of magnetic particles 88b respectively in vertical directions. As a result, each of the magnetic particles 88b has a hcp crystal structure extending vertically as the non-magnetic foundation layer 87, with the height directions of the hexagonal column of the hcp structure (c-axis) being the axis of easy magnetization, so that the first recording layer 88 is made to have a perpendicular magnetic anisotropy.

Incidentally, though the non-magnetic material 88a in the first recording layer 88 of this embodiment is made of SiO₂, the non-magnetic material 88a can be made of other oxides than SiO₂. Examples of such oxides as the material for non-magnetic material 88a are oxides of any one element of Ta, Ti, Zr, Cr, Hf, Mg and Al. Alternatively, the non-magnetic material 88a can be made of nitrides of any one element of Si, Ta, Ti, Zr, Cr, Hf, Mg and Al.

In addition, the magnetic particles 88b can be made of, beside the above-mentioned CoCrPt, an alloy containing any one metal element of Co, Ni and Fe.

Still next, steps up to a point where the structure shown in FIG. 17C is formed will be explained. Firstly, after the formation of the first recording layer 88 in the above described way, a second recording layer 89 is formed on the first recording layer 88. The second recording layer 89 is formed as a CoCrPtB layer with a thickness, for example, of 6 nm, and with a hcp structure by a DC sputtering method with an input electric power of 400 W in an Ar atmosphere.

The second recording layer 89 formed on the first recording layer 88 has a perpendicular magnetic anisotropy as in the case of the first recording layer 88. The CoCrPtB layer constituting the second recording layer 89 has a hcp structure, which is the same as each of the magnetic particles 88b in the first recording layer 88 just below the second recording layer 89. As a result, the second recording layer 89 is formed on the first recording layer 88 to have a favorable crystallinity. Note that the second recording layer 89 is not limited to the CoCrPtB layer. The second recording layer 89 can be formed as a layer made of an alloy containing at least one element of Co, Ni and Fe.

Secondly, after the second recording layer 89 is formed in the way described above, a diamond like carbon (DLC) layer is formed on the second recording layer 89 in a thickness of approximately 4 nm as a protect layer 90 by a radio-frequency chemical vapor deposition method (RF-CVD method) with a reaction gas of C₂H₂. The conditions under which the film of the protecting layer 90 is formed are, for example, a pressure of approximately 4 Pa, an input radio-frequency electric power of 1000 W, a 200 V bias voltage between the base plate and a shower head, and a temperature of the base plate at 200° C.

Thirdly, after an lubricant (not illustrated) is applied in a thickness of approximately 1 nm on the protect layer 90, protrusions and foreign matters are removed from the surface of the protect layer 90 with a polishing tape. In this way, the manufacturing of the magnetic recording medium of this embodiment is completed. Incidentally, the protect layer 90 and the lubricant layer are not integral constituents of the present invention. For this reason, these layers can be formed when needed.

In the magnetic recording medium configured as is described above, the magnetic field occurring in the magnetic head (in the main magnetic pole of the recording element) reaches the underlayer passing through the first and the second recording layers 88 and 89. At this time, since the main magnetic pole is made to have such an area of a cross section thereof as to increase the magnetic flux density, the information is magnetically recorded when the first and the second recording layers 88 and 89 are vertically magnetized. On the other hand, the magnetic field, once reached the underlayer 84, proceeds to pass through the underlayer 84 in an in-plane direction, then through the first and the second recording layers 88 and 89, and flows back to the magnetic head (to the auxiliary magnetic pole of the recording element). At this time, since the auxiliary magnetic pole is made to have such an area of a cross section thereof as to decrease the magnetic flux density, the magnetization directions of the first and the second recording layers 88 and 89 are not affected.

In the magnetic recording medium of this embodiment, the underlayer (exchange coupling film) 84 has a high exchange coupling energy. This suppresses the side erasure and the spike noise, and prevents the recording area from spreading.

(Magnetic Recording Apparatus)

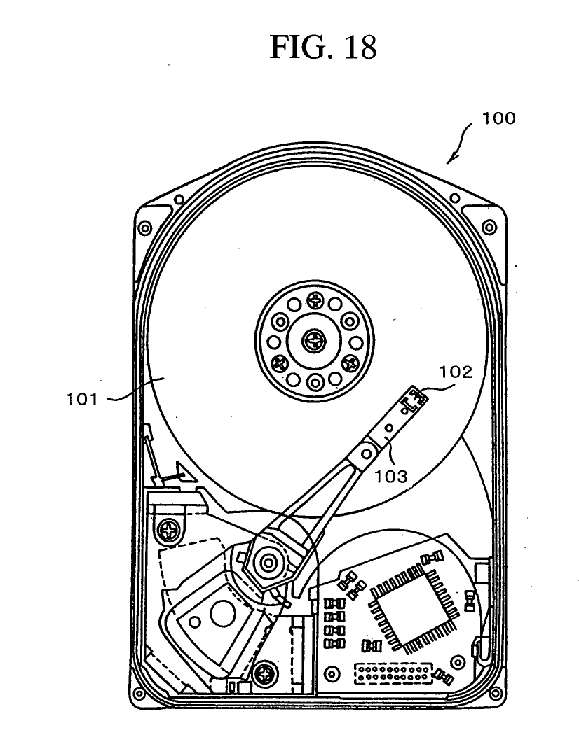

FIG. 18 is a plan view showing a magnetic recording apparatus.

A magnetic recording apparatus 100 has, in its casing, a disc-shaped magnetic recording medium (magnetic disc) 101, a spindle motor (not illustrated), a magnetic head 102, a suspension 103 and an actuator (not illustrated). The spindle motor rotates the magnetic disc 101. The magnetic head 102 records data in, and reads data out. The suspension 103 holds the magnetic head 102. The actuator controls the drive of the suspension 103 in a radius direction of the magnetic disc 101.

The magnetic head 102 and the magnetic recording medium 101 have such structures respectively as being described above in the embodiment.

A rapid rotation of the magnetic recording device 101 by the spindle motor generates an airflow, which causes the magnetic recording head 102 to float slightly from the magnetic recording medium 101. The actuator causes the magnetic head 102 to move in a radius direction of the magnetic recording medium 101, and thus the magnetic head 102 records data in, and reads data out of, the magnetic recording medium 101.

Use of a magnetic recording apparatus with such a configuration equipped with the magnetic head 102 and the magnetic recording medium 101, respectively with structures described above improves the reliability of the data recorded in the magnetic recording medium 101.

(MRAM)

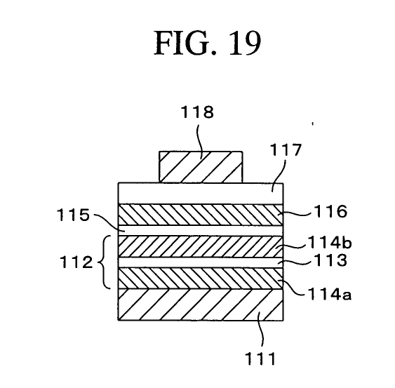

FIG. 19 is a sectional view showing an example of the present invention applied to a reference layer of a TMR element constituting an MRAM.

The TMR element constituting the MRAM includes an antiferromagnetic layer 111, a reference layer (exchange coupling film) 112, a tunnel barrier layer 115, a recording layer 116, an insulating layer 117, and a wiring (word lines) 118. The reference layer 112 includes a non-magnetic layer 113 made of a Ru— Rh alloy with a thickness of 0.3 nm to 0.7 nm, and two soft magnetic layers (ferromagnetic layers) 114a and 114b, arranged with this non-magnetic layer 113 being interposed in between.

The soft magnetic layers 114a and 114b are made of a ferromagnetic material containing at least one element of Fe, Ni and Co. The antiferromagnetic layer 111 is a thin film made of an antiferromagnetic material such as PtMn. The recording layer 116 is made of a ferromagnetic material (semi-hard magnetic film) containing at least one element of Fe, Ni and Co. The basic structure and operation of the MRAM are described in Japanese Patent Application No. 2004-103125.

In the MRAM of the embodiment of the present invention with this configuration, the non-magnetic layer 113 of the reference layer 112 is made of a Ru—Rh alloy, so that the exchange coupling energy is high. As a result, in comparison to a conventional MRAM with a non-magnetic layer made of Ru, the MRAM of the present invention has a larger coercive force of the recording layer 116, and thus the stability of the magnetic field and the thermal stability are improved.

The non-magnetic layer 113 is preferably made of a Ru—Rh alloy with a Rh contents of 5 at % to 40 at %. In addition, the thickness of the non-magnetic layer 113 is preferably equal to 0.3 nm to 0.7 nm, and more preferably equal to 0.4 nm to 0.7 nm.

Note that, in the above embodiment, explanations has been given of a case in which the present invention is applied to the reference layer of the MRAM. The present invention can be applied to a recording layer to make the recording layer with a synthetic ferri free structure. In other words, the recording layer can be made to include a non-magnetic layer made of a Ru—Rh alloy with a thickness of 0.3 nm to 0.7 nm, and a first and a second ferromagnetic layers, which sandwich the non-magnetic layer. In this case, when the saturation magnetization and the thickness of the first magnetic layer are indicated as respectively M1 and t1, and when their counterparts of the second magnetic layer are indicated as M2 and t2, M1, t1, M2 and t2 are set to have a relationship expressed as M1·t1≠M2·t2.

What is claimed is:

1. An exchange coupling film comprising:
a non-magnetic layer; and
a first ferromagnetic layer and a second ferromagnetic layer which are arranged with the non-magnetic layer in between, and which are exchange coupled with each other so that the magnetization directions thereof can be antiparallel,
wherein the non-magnetic layer is made of a Ru— Rh alloy.

2. The exchange coupling film as recited in claim 1 used in a magnetic device which is subjected to a heat treatment in its manufacturing process, the exchange coupling film wherein the Rh content in the Ru—Rh alloy is 40 at % or lower.

3. The exchange coupling film as recited in claim 1 used in a magnetic device which needs no heat treatment in its manufacturing process, the exchange coupling film wherein the Rh content in the Ru—Rh alloy is 70 at % or lower.

4. The exchange coupling film as recited in claim 3, wherein the first and the second ferromagnetic layers are made of an alloy containing Co, Fe and B.

5. The exchange coupling film as recited in claim 1, wherein the Rh content in the Ru—Rh alloy is 5 at % to 40 at % inclusive.

6. The exchange coupling film as recited in any one of claims 1 to 3, wherein the non-magnetic layer has a thickness of 0.3 nm to 0.7 nm inclusive.

7. The exchange coupling film as recited in any one of claims 1 to 3, wherein the first and the second ferromagnetic layers contain at least one element of Co, Ni and Fe.

8. A magnetic head which reads information out of a magnetic recording medium, the magnetic head comprising:
a base plate;
a first magnetic shield layer formed on the base plate;
an antiferromagnetic layer formed on the first magnetic shield layer;
an exchange coupling film formed on the antiferromagnetic layer;
a barrier layer formed on the exchange coupling film;
a free layer formed on the barrier layer; and
a second magnetic shield layer formed on the free layer,
the magnetic head wherein the exchange coupling film has a configuration with a non-magnetic layer of a Ru—Rh alloy, and with a first and a second ferromagnetic layers which are arranged with the non-magnetic layer in between, and which are exchange coupled with each other so that the magnetization directions thereof can be antiparallel.

9. The magnetic head as recited in claim 8, wherein the non-magnetic layer has a thickness of 0.4 nm to 0.5 nm inclusive.

10. The magnetic head as recited in claim 8, wherein the Rh content in the Ru—Rh alloy is 5 at % to 40 at % inclusive.

11. A magnetic recording medium which magnetically records information, the magnetic recording medium comprising:
a base plate;
an exchange coupling film formed on the base plate;
a crystalline orientation layer formed on the exchange coupling film; and
a recording layer formed on the crystalline orientation layer,
the magnetic recording medium wherein the exchange coupling film has a configuration with a non-magnetic layer of a Ru—Rh alloy, and with a first and a second ferromagnetic layers which are arranged with the non-magnetic layer in between, and which are exchange coupled so that the magnetization directions thereof can be antiparallel.

12. The magnetic recording medium as recited in claim 11, wherein the recording layer has a granular structure.

13. The magnetic recording medium as recited in claim 11, wherein the non-magnetic layer has a thickness of 0.3 nm to 0.7 nm inclusive.

14. The magnetic recording medium as recited in claim 11, wherein the exchange coupling film has a thickness of 10 nm to 100 nm inclusive.

15. The magnetic recording medium as recited in claim 11, wherein the Rh content in the Rh—Rh alloy is 5 at % to 70 at % inclusive.

16. An MRAM which magnetically records information with a magnetoresistance effect element, the MRAM comprising:
an antiferromagnetic layer;
a reference layer formed on the antiferromagnetic layer;
a barrier layer formed on the reference layer;
a recording layer formed on the barrier layer; and
a wiring arranged above the recording layer with an insulating layer interposed in between,
the MRAM wherein at least any one of the reference layer and the recording layer has a configuration with a non-magnetic layer of a Ru—Rh alloy, and with a first and a second ferromagnetic layers which are arranged with the non-magnetic layer in between, and which are exchange coupled so that the magnetization directions thereof can be antiparallel.

17. The MRAM as recited in claim 16, wherein the non-magnetic layer has a thickness of 0.3 nm to 0.7 nm inclusive.

18. The MRAM as recited in claim 16, wherein the Rh content in the Ru—Rh alloy is 5 at % to 40 at % inclusive.
